(19) United States
(12) Patent Application Publication
(10) Pub. No.: US 2023/0108156 A1
(43) Pub. Date: Apr. 6, 2023

(54) MULTI-THREADED PROTOCOL-AGNOSTIC PROACTOR FACADE FOR HTTP/2 SERVER IMPLEMENTATIONS

(71) Applicant: VMware, Inc., Palo Alto, CA (US)

(72) Inventors: Seraphime Kirkovski, Sofia (BG); Nikola Kaludov, Sofia (BG); Georgi L. Lyubomirov Dimitrov, Sofia (BG); Anton Stoyanov, Sofia (BG); Georgi Lekov, Sofia (BG)

(21) Appl. No.: 17/959,161

(22) Filed: Oct. 3, 2022

Related U.S. Application Data
(60) Provisional application No. 63/252,089, filed on Oct. 4, 2021.

(51) Int. Cl. H04L 67/02; G06F 9/451; H04L 67/14

(52) U.S. Cl. CPC H04L 67/02; G06F 9/451; H04L 67/14

(57) ABSTRACT

Some embodiments provide a method of facilitating a multi-stream protocol for a split web server that includes a reactor core and a proactor interface. At a session object of the web server, the method generates an internal stream for a new incoming web-based protocol stream. The method transfers a set of data associated with the new incoming web-based protocol stream to a buffer of the internal stream from which a user-facing interface of the web server reads the data. In response to a first data byte sent by the user-facing interface, the method initiates an active write loop for the new web-based protocol stream.

### BACKGROUND

Today, large service appliances all have an HTTP server to handle incoming requests. These HTTP servers provide a server-side interface so that appliance developers can read requests and construct responses using high level application programming interface (API) functions. Such server-side APIs allow their users (e.g., appliance developers) to leverage the server capabilities without in-depth knowledge of HTTP. However, the APIs of HTTP server implementations fail to fully abstract away input/output (I/O) internals from the user. HTTP/1 does not have a built-in expectation to the I/O model, thereby allowing developers to implement proactor or reactor models.

When HTTP/2 was published in 2015, it enabled a more efficient use of network resources compared to HTTP/1. However, this improved performance has required a vastly disparate implementation approach. In short, HTTP/2+ protocols have a reactor pattern model, and require constant polling of the network for more data. Unlike HTTP/1, where the closing of a connection is as simple as closing the socket, the HTTP/2 connection state is not impacted by the closing of a single stream, and multiple streams are interleaved into a single connection.

As a result, HTTP server implementations have had to introduce a new set of APIs that are consistent with the new I/O internal model. While this is not an issue for small-scale software or the HTTP server implementation itself, as they require a small number of isolated changes to make old and new HTTP to work seamlessly, is has become an issue for large scale service appliances, such as VMware, Inc.'s vCenter Server, since the existing, custom-made server-side APIs have been used for a long-time and have spread across multiple services. A refactoring effort will cost the time of many engineers across different teams.

### BRIEF SUMMARY

Some embodiments of the invention provide a method of facilitating a multi-stream protocol for a split web server comprising a reactor core and a proactor interface. A session object of the web server (e.g., an HTTP/2 server) generates an internal stream for a new incoming web-based protocol stream (e.g., an HTTP/2 stream). The session object transfers a set of data associated with the new incoming web-based protocol stream to a buffer of the internal stream from which a user-facing interface of the web server (also referred to herein as a transaction) reads the data. In response to a first data byte being sent by the user-facing interface, the session object initiates an active write loop for the new web-based protocol stream.

In some embodiments, the reactor core of the web server includes the session object and the internal stream, while the proactor interface includes the user-facing interface. The session object and the user-facing interface, in some embodiments, each have a reference to the internal stream. However, in some embodiments, the internal stream only has a reference to the session object, and not to the user-facing interface. In some embodiments, the user-facing interface releases its reference to the internal stream after sending a final data byte.

The session object, in some embodiments, is created in response to the acceptance by the web server of a new web-based protocol connection (e.g., an HTTP/2 connection). In some embodiments, the session object generates an internal stream for each incoming web-based protocol stream associated with the web-based protocol connection for which the session object was created. Each internal stream, in some embodiments, is associated with a respective user-facing interface. In some embodiments, the user-facing interfaces can only be destroyed by the user.

In some embodiments, the session object determines that a second connection request has been accepted, and generates a second stream for the additional connection. The session object then transfers a set of data associated with the second incoming connection to a buffer of the second stream to be read by a second transaction, according to some embodiments. In response to a first data byte sent by the second transaction, the session object in some embodiments initiates an active write loop for the second new web-based protocol stream.

In some embodiments, the session object implements a state machine of the web server. The state machine, in some embodiments, begins the process of fetching and packaging data, and registers the internal stream as a data source, following a signal that the first data byte is sent by the transaction. The state machine, in some embodiments, then provides any ready encrypted frames to the session object, causing the session object to initiate the active write loop. The session object, in some embodiments, only performs asynchronous reads of data messages.

When a transaction is prematurely terminated, in some embodiments, it sends an alert to its stream, which then sends a notification to the session object indicating the transaction has been terminated. Depending on the state, either the internal stream is autocompleted, or the HTTP/2 stream associated with the internal stream is terminated, in some embodiments. Alternatively, when the transaction is completed gracefully, the internal stream is returned to an internal stream pool of the session object.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIG. 1 illustrates a lifecycle diagram for a split-model web server that includes a reactor core and a proactor interface, in some embodiments.

FIG. 2 illustrates a process performed by a session object, in some embodiments, during the lifecycle of an internal stream.

FIGS. 3-4 illustrate a web server on which a session object creates streams for incoming HTTP/2 streams, in some embodiments.

FIG. 5 illustrates a process performed by the HTTP/2 state machine implemented by the session, in some embodiments.

FIGS. 6-7 illustrate an example embodiment of a web server at two different times T1 and T2, during which a stream is created and another stream is returned to a stream pool.

FIG. 8 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method of facilitating a multi-stream protocol for a split web server comprising a reactor core and a proactor interface. The web server, in some embodiments, is an HTTP/2 server in which I/O internals are abstracted away from the application programming interface (API) user, and vice versa. The API user is protocol-agnostic, and the HTTP/2 implementation is multi-threaded in addition to being multi-stream.

In some embodiments, a session object of the web server (e.g., an HTTP/2 server) generates an internal stream for a new incoming web-based protocol stream (e.g., an HTTP/2 stream). The session object transfers a set of data associated with the new incoming web-based protocol stream to a buffer of the internal stream from which a user-facing interface of the web server (also referred to herein as a transaction) reads the data. In response to a first data byte being sent by the user-facing interface, the session object initiates an active write loop for the new web-based protocol stream.

The reactor core of the web server, in some embodiments, includes the session object and the internal stream, while the proactor interface includes the user-facing interface. The session object and the user-facing interface, in some embodiments, each have a reference to the internal stream. However, in some embodiments, the internal stream only has a reference to the session object, and not to the user-facing interface. In some embodiments, the user-facing interface releases its reference to the internal stream after sending a final data byte.

The session object, in some embodiments, is created in response to the acceptance by the web server of a new web-based protocol connection (e.g., an HTTP/2 connection). In some embodiments, the session object generates an internal stream for each incoming web-based protocol stream associated with the web-based protocol connection for which the session object was created. Each internal stream, in some embodiments, is associated with a respective user-facing interface. In some embodiments, the user-facing interfaces can only be destroyed by the user.

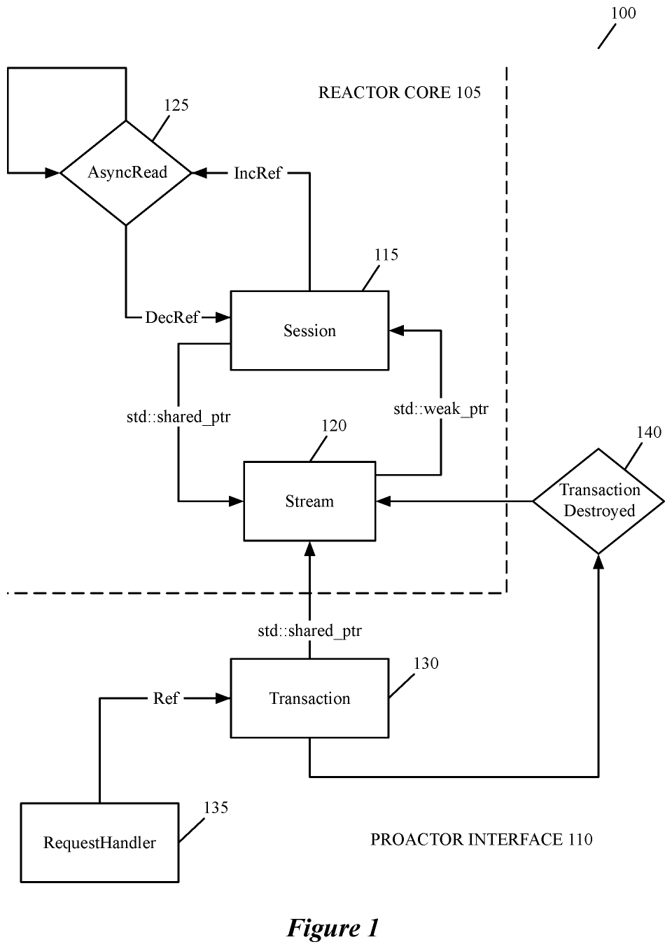

FIG. 1 illustrates a lifecycle diagram for a split-model web server that includes a reactor core and a proactor interface, in some embodiments. As shown, the diagram 100 includes a reactor core 105 and a proactor interface 110. The reactor core 105 includes a session object 115, an internal stream 120, while the proactor interface 110 includes a transaction 130 and request handler 135.

In some embodiments, the reactor core 105 is responsible for responding to I/O (input/output). The session object 115, in some embodiments, is a message bus that contains HTTP/2 stream management logic and that arbitrates I/O for the streams. In some embodiments, the session object 115 also represents an HTTP/2 connection from the I/O and the protocol point of value (POV). To perform I/O, the session object 115 in some embodiments must fetch bytes from the connection. In some embodiments, the session object 115 only performs asynchronous reads, as indicated by 125.

The session holds the only strong reference to itself, according to some embodiments. In some embodiments, asynchronous I/O callbacks capture this reference, and as such, the session is alive while there is pending I/O. However, if there is an I/O error or a processing error, the session object 115 gets deleted, according to some embodiments. In some embodiments, there is no other way for the session to be terminated.

The proactor interface 110, in some embodiments, is controlled from the user API. In some embodiments, the transaction 130 is a high-level, protocol-agnostic, user-facing HTTP interface that is completely independent from the reactor core 105. Additionally, the reactor core 105 does not hold references to the proactor interface 110 and therefore does not control it. The request handler 135, in some embodiments, is the code that receives a reference pointer to the transaction 130 when a new request arrives. In some embodiments, if the request handler 135 drops the reference to the transaction 130, the transaction will die.

In some embodiments, in addition to being a high-level, protocol-agnostic, user-facing HTTP interface, the transaction 130 is also a reference-counted object that can only be destroyed by a user. The transaction 130 and the session object 115 hold a shared reference to the stream 120. If the underlying session of the session object 115 is destroyed, in some embodiments, the internal stream 120 will signal it to the transaction 130 through an exception. Otherwise, the transaction 130 releases its reference to the internal stream 120 upon completing its message, in some embodiments.

When the transaction 130 is prematurely terminated, in some embodiments, it sends an alert 140 to the stream 120, which then sends a notification to the session object 115 indicating the transaction 130 has been terminated. Depending on the state, either the internal stream 120 is autocompleted, or the HTTP/2 stream (not shown) associated with the internal stream is terminated, in some embodiments. Alternatively, when the transaction 130 is completed gracefully, the internal stream is returned to an internal stream pool of the session object.

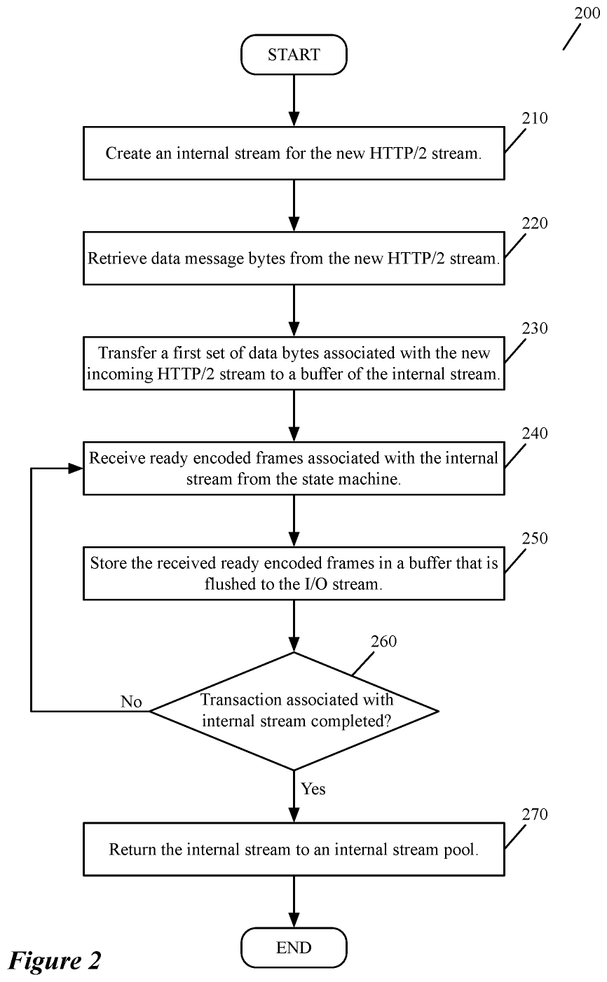

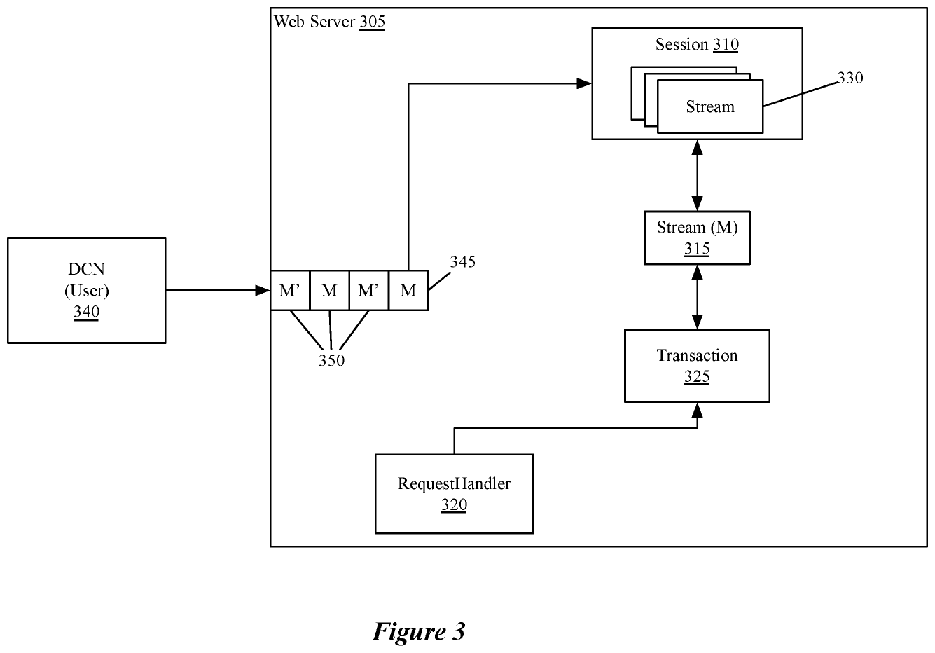

FIG. 2 illustrates a process performed by a session object, in some embodiments, during the lifecycle of an internal stream. FIG. 2 will be described with reference to the web server 305 illustrated by FIG. 3. The process 200 starts by creating (at 210) an internal stream for a new HTTP/2 stream associated with an HTTP/2 connection for which the session object was created. In some embodiments, the internal stream is created in response to receiving a data message associated with the HTTP/2 connection from a machine external to the web server. The streams, in some embodiments, are stored in a pool and can be reused. For instance, the session object 310 includes a stream pool 330. The process retrieves (at 220) data message bytes from the new HTTP/2 stream. The session 310 of the web server 305, for example, retrieves data message bytes from the data messages 345 and 350. In this example, while all of the data messages 345 and 350 are received from the user machine 340 and are associated with the same HTTP/2 connection as indicated by their arrival to a queue of the session 310, each data message is denoted with either “M” or “M′”, indicating they are associated with different HTTP/2 streams. The different HTTP/2 streams will be discussed in further detail below.

The process transfers (at 230) a first set of data bytes associated with the new HTTP/2 stream to a buffer of the internal stream, where the bytes can be read by the transaction. The session 310, for instance, transfers bytes associated with the data message 345 to a buffer (not shown) of the stream 315 to be read by the transaction 325. When a new request (i.e., HTTP/2 stream) arrives, the request handler 320, in some embodiments, receives a reference pointer to the appropriate transaction for that request. In some embodiments, each transaction is created on demand, and discarded once the request handler 320 is done with them.

In some embodiments, there are two levels of read buffers. One of the two read buffers, in some embodiments, is contained within the session and holds the raw data from the I/O. Additionally, there is one buffer within every stream, holding application data, according to some embodiments. In some embodiments, the HTTP/2 state machine within the session decodes the raw bytes fetched from the I/O and invokes the appropriate stream callbacks. Upon receiving application data, in some embodiments, if an internal stream's transaction has scheduled a pending read, the data is transferred directly into the target buffer of the internal stream. Otherwise, it is stored in the internal stream's internal buffer, in some embodiments, and the internal stream and connection window size are adjusted accordingly. In some embodiments, the transaction proactively reads the data from the internal stream. To defend from DoS (denial-of-service) attacks, in some embodiments, back pressure from the protocol is relied upon.

Transactions, in some embodiments, are responsible for starting the data writing process. Data bytes from the transaction are stored in an internal buffer of the internal stream, in some embodiments, and the internal stream applies back pressure if its write buffer is full by blocking or delaying callbacks. In some embodiments, metadata (e.g., headers) of data messages are transmitted once the transaction sends the first data byte. This signals the HTTP/2 state machine within the session to begin the process of fetching and packaging data, in some embodiments, and to register the internal stream as a data source, as will be further described below.

Returning to the process 200, the process receives (at 240) ready encoded frames (i.e., data messages that have been divided up and separated (e.g., separated into header frames and data frames)) associated with the internal stream. These frames are received from the state machine implemented by the session, in some embodiments.

The process stores (at 250) the received frames in a buffer of the session that is flushed to the I/O stream. The process then determines (at 260) whether the transaction associated with the internal stream has completed. That is, the process determines whether the transaction is still sending data bytes to the stream, according to some embodiments. When the process determines (at 260) that the transaction has not completed and is still sending data messages, the process returns to 240 to continue to receive ready encoded frames associated with the internal stream from the state machine.

When the process determines (at 260) that the transaction has completed, the process transitions to return (at 270) the internal stream to an internal stream pool. The stream 315, for instance, could be returned to the stream pool 330 of the session 310. In some embodiments, when a transaction has completed its message (i.e., sent its last bytes), it releases its reference to the internal stream. Following 270, the process 200 ends.

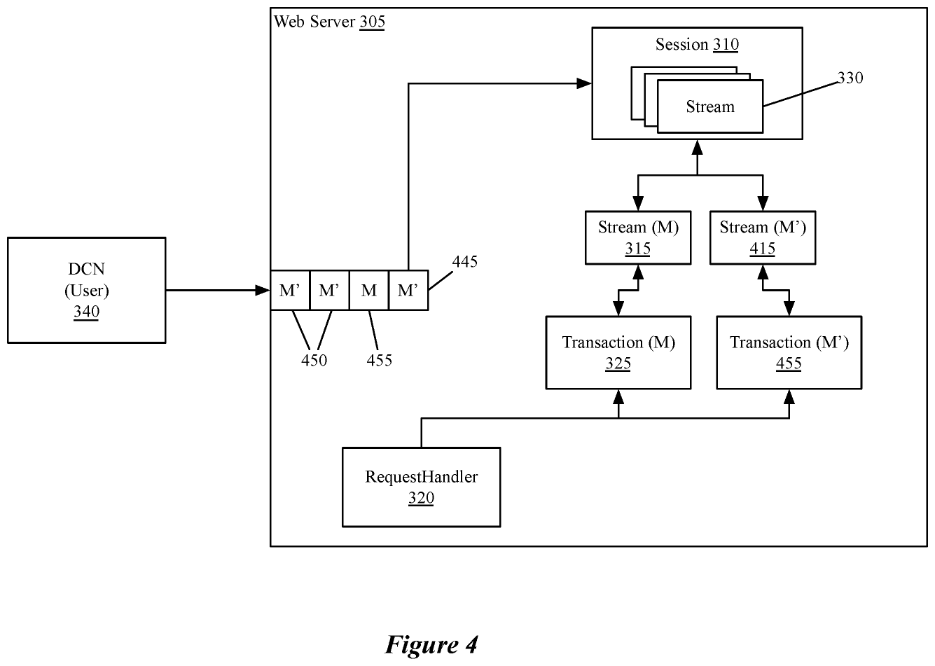

In some embodiments, the session performs the process 200 for multiple streams simultaneously. FIG. 4 illustrates the web server 305 after the session 310 has added an additional stream associated with its connection with the user machine 340. As mentioned above, the data messages in the queue of the session 310 are associated with different HTTP/2 streams “M” and “M′”.

As shown, the stream 315 has not yet been terminated, and there is at least one more incoming data message 455 associated with this stream. The session 310 has created another stream 415 for the data messages 445 and 450. In some embodiments, the session object 310 creates an internal stream 315/415 for each incoming HTTP/2 stream. As mentioned above, the streams, in some embodiments, are prebuilt and stored in a stream pool and can be reused.

Each stream, in some embodiments, is shared between the session and a transaction. In some embodiments, each stream holds a weak reference to the session, but does not hold a reference to its transaction. If the session 310 is destroyed, in some embodiments, the streams 315 and 415 throw an exception on calls from their transactions, indicating that the I/O connection has been closed.

For the HTTP/2 stream associated with the internal stream 415, the request handler 320 receives a reference to the transaction 455 with the request for said HTTP/2 stream. Unlike the streams, the transactions 325 and 455 are created on-demand, in some embodiments, and are discarded upon completion of their messages. In some embodiments, a transaction is discarded when the request handler 320 releases its reference to the transaction.

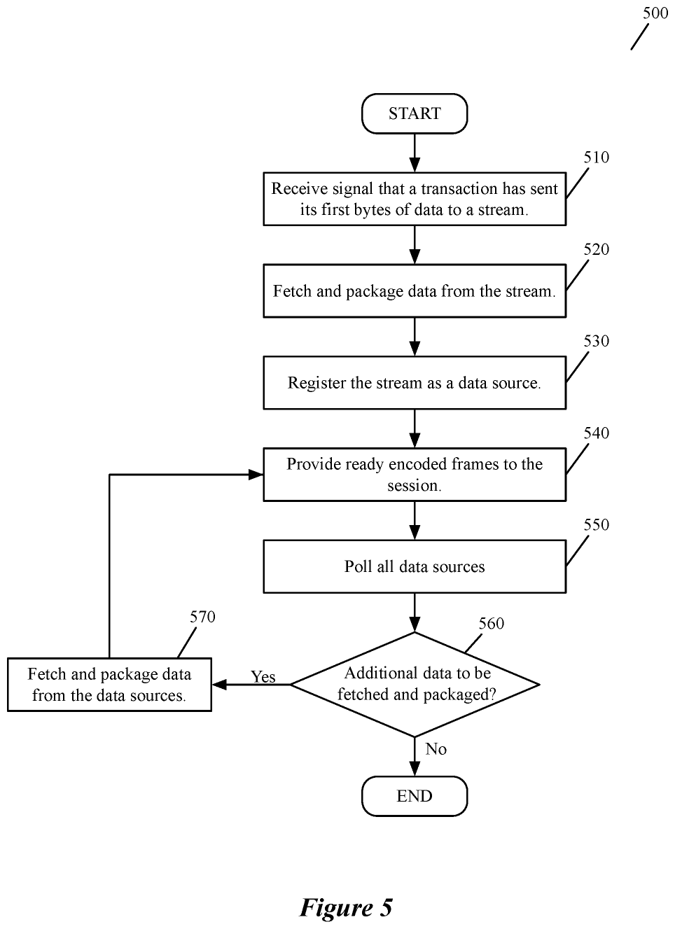

FIG. 5 illustrates a process performed by the HTTP/2 state machine implemented by the session, in some embodiments. The process 500 starts by receiving (at 510) a signal that a transaction has sent its first bytes of data to a stream. In response to this signal, the process fetches and packages (at 520) data from the stream. In some embodiments, packaging the data includes separating the data into different frames, such as header frames, and data frames (i.e., body frames). Separating the header frames from the data frames enables the headers to be compressed, according to some embodiments.

The process then registers (at 530) the stream as a data source. The state machine, in some embodiments, registers multiple different streams associated with the session as data sources. For instance, the state machine (not shown) implemented by the session 310 of the web server 305 would have at least two data sources registered (i.e., streams 315 and 415).

The process provides (at 540) ready encoded frames to the session. In some embodiments, the session requests any ready encoded frames from the state machine. Also, in some embodiments, the state machine returns frames to the session automatically and independently of the streams.

The process polls (at 550) all of its data sources (e.g., streams) for data and determines (at 560) whether there is any additional data to be fetched and packaged. When the process determines (at 560) that there is additional data to be fetched and packaged, the process transitions to 570 to fetch and package data from the data sources. The process then returns to 540 to provide any ready encoded frames to the session.

When the process determines (at 560) that there is no additional data to be fetched and packaged (i.e., there are no streams still receiving data from their transactions), the process 500 ends. In some embodiments, because the session is kept alive by pending and/or processing I/O, the session may be terminated as a result of this determination, if there are no more incoming HTTP/2 streams for the corresponding HTTP/2 connection. As an alternative, in some embodiments, the stream may instead inform the state machine that it does not currently have any data, prompting the state machine to stop polling that particular stream until it receives an explicit notification from the stream that there is more data to be fetched. In some embodiments, this is referred to as write loop pausing.

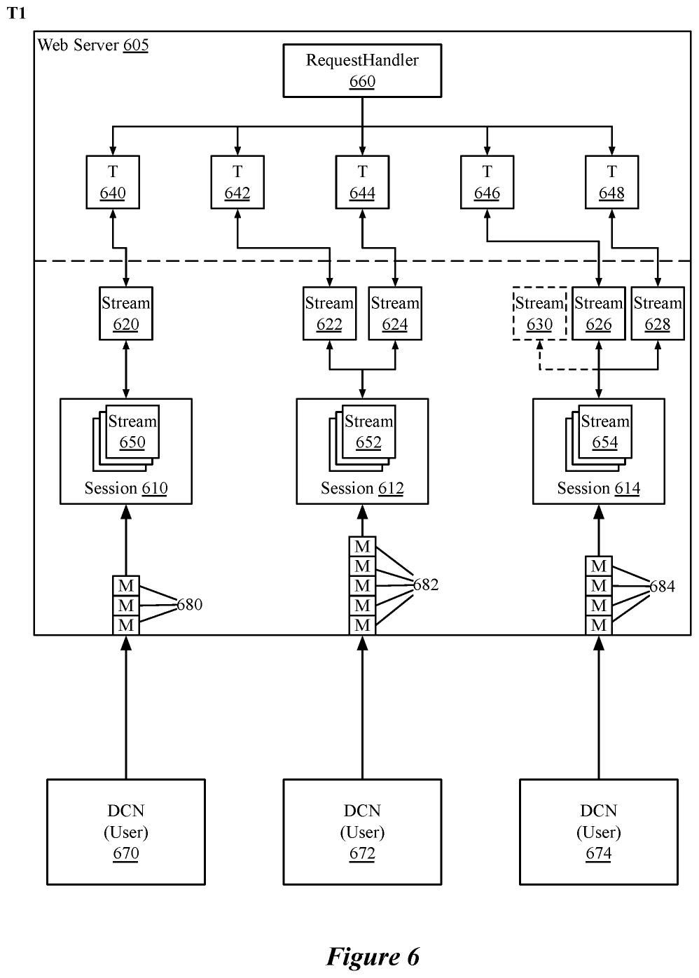

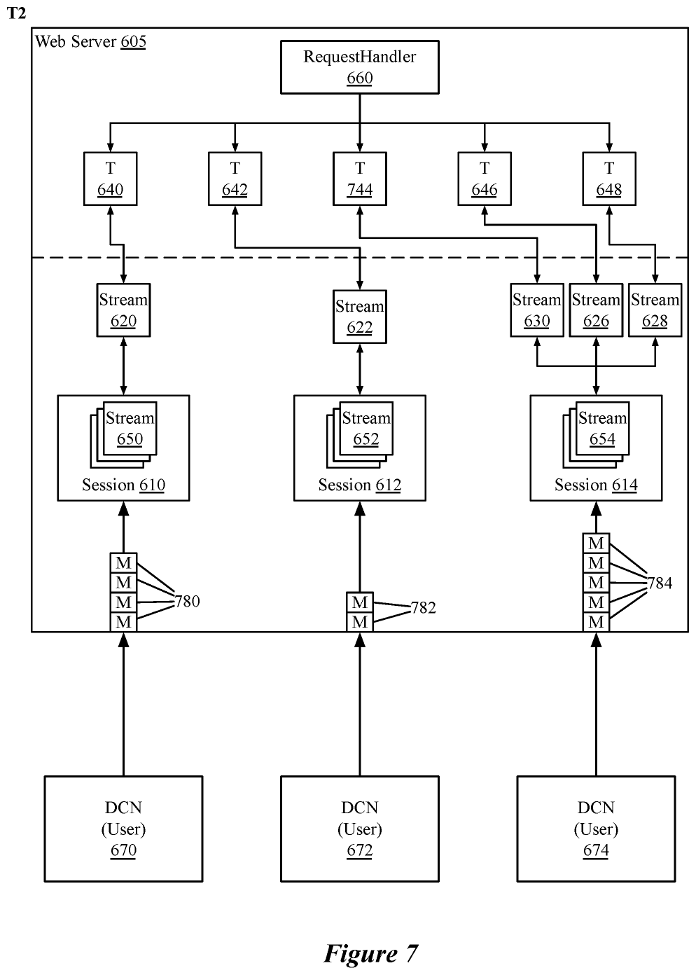

As mentioned above, the streams, in some embodiments, are prebuilt and stored in a stream pool. When a transaction ends and its corresponding stream has been released, in some embodiments, the stream is returned to the stream pool and can be reused. Conversely, the transactions are created on-demand, in some embodiments, and are destroyed upon completing their final message. FIGS. 6 and 7 illustrate an example embodiment of a web server 605 at two different times T1 and T2, during which a stream is created and another stream is returned to a stream pool. As shown, multiple sessions have been created for the web server 605 based on its multiple HTTP/2 connections user machines 670, 672, and 674.

The web server 605 includes session 610 associated with the HTTP/2 connection with user machine 670, session 612 associated with the HTTP/2 connection with user machine 672, and session 614 associated with the HTTP/2 connection with user machine 674. Session 610 includes a stream pool 650 and has created stream 620 for the HTTP/2 stream with which data messages 680 are associated. Transaction 640 shares a reference to the stream 620 with the session 610, indicating request handler 660 received a reference to transaction 640 for this HTTP/2 stream.

The session 612 includes a stream pool 652 and has created two streams 622 and 624 for data messages 682. Transaction 642 shares a reference with the session 612 to stream 622, while transaction 644 shares a reference with session 612 to stream 624. The session 614, like the session 612, has also created multiple streams. As shown, the session 614 includes a stream pool 654 and has created three streams, 630, 626, and 628 for data messages 684. While the transaction 646 shares a reference with the session 614 to stream 626, and transaction 648 shares a reference with the session 614 to stream 628, no transactions are shown holding a reference (i.e., shown having an arrow to) the stream 630, which is illustrated with a dashed outline to indicate this stream has just been created. While each session is illustrated as having its own stream pool, the sessions in other embodiments share the same stream pool.

Because the transactions are included in the proactor portion of the web server 605, they have no control over the order in which asynchronous operations are executed, and therefore have no control over scheduling and controlling pending operations. As a result, in some embodiments, transactions are created for the streams based on the order in which the request handler 660 receives data regarding new streams (i.e., as opposed to a priority order).

In FIG. 7, stream 630 no longer appears with a dashed outline, and a new transaction 744 is illustrated as sharing a reference to the stream 630 with the session 614. Additionally, the transaction 644 has been terminated, and the stream 624 has been returned to the stream pool 652 of the session 612.

Additionally, the number of data messages in each queue has changed between FIG. 6 and FIG. 7, and each of the sessions remains alive, as shown, with four data messages 780 in the queue for session 610 and stream 620, two data messages 782 in the queue for session 612 and stream 622, and five data messages 784 in the queue for session 614 and streams 630, 626, and 628.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

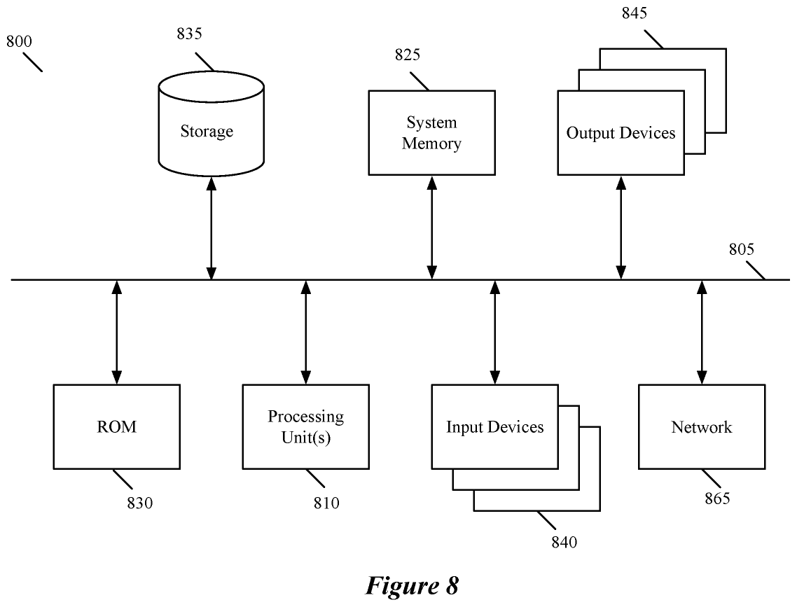

FIG. 8 conceptually illustrates a computer system 800 with which some embodiments of the invention are implemented. The computer system 800 can be used to implement any of the above-described hosts, controllers, gateway, and edge forwarding elements. As such, it can be used to execute any of the above described processes. This computer system 800 includes various types of non-transitory machine-readable media and interfaces for various other types of machine-readable media. Computer system 800 includes a bus 805, processing unit(s) 810, a system memory 825, a read-only memory 830, a permanent storage device 835, input devices 840, and output devices 845.

The bus 805 collectively represents all system, peripheral, and chipset buses that communicatively connect the numerous internal devices of the computer system 800. For instance, the bus 805 communicatively connects the processing unit(s) 810 with the read-only memory 830, the system memory 825, and the permanent storage device 835.

From these various memory units, the processing unit(s) 810 retrieve instructions to execute and data to process in order to execute the processes of the invention. The processing unit(s) 810 may be a single processor or a multi-core processor in different embodiments. The read-only-memory (ROM) 830 stores static data and instructions that are needed by the processing unit(s) 810 and other modules of the computer system 800. The permanent storage device 835, on the other hand, is a read-and-write memory device. This device 835 is a non-volatile memory unit that stores instructions and data even when the computer system 800 is off. Some embodiments of the invention use a mass-storage device (such as a magnetic or optical disk and its corresponding disk drive) as the permanent storage device 835.

Other embodiments use a removable storage device (such as a floppy disk, flash drive, etc.) as the permanent storage device. Like the permanent storage device 835, the system memory 825 is a read-and-write memory device. However, unlike storage device 835, the system memory 825 is a volatile read-and-write memory, such as random access memory. The system memory 825 stores some of the instructions and data that the processor needs at runtime. In some embodiments, the invention's processes are stored in the system memory 825, the permanent storage device 835, and/or the read-only memory 830. From these various memory units, the processing unit(s) 810 retrieve instructions to execute and data to process in order to execute the processes of some embodiments.

The bus 805 also connects to the input and output devices 840 and 845. The input devices 840 enable the user to communicate information and select commands to the computer system 800. The input devices 840 include alphanumeric keyboards and pointing devices (also called “cursor control devices”). The output devices 845 display images generated by the computer system 800. The output devices 845 include printers and display devices, such as cathode ray tubes (CRT) or liquid crystal displays (LCD). Some embodiments include devices such as touchscreens that function as both input and output devices 840 and 845.

Finally, as shown in FIG. 8, bus 805 also couples computer system 800 to a network 865 through a network adapter (not shown). In this manner, the computer 800 can be a part of a network of computers (such as a local area network (“LAN”), a wide area network (“WAN”), or an Intranet), or a network of networks (such as the Internet). Any or all components of computer system 800 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method of facilitating a multi-stream protocol for web server, the method comprising:
at a session object of the web server:
generating an internal stream for a new incoming web-based protocol stream;
transferring a set of data associated with the new incoming web-based protocol stream to a buffer of the internal stream, wherein a user-facing interface of the web server reads data from the buffer; and
in response to a first data byte sent by the user-facing interface, initiating an active write loop for the new web-based protocol stream.

2. The method of claim 1, wherein the web server comprises a split web server that includes rising a reactor core and a proactor interface, and the reactor core of the web server comprises the session object and the internal stream, while the proactor interface comprises the user-facing interface.

3. The method of claim 2, wherein:
the session object and the user-facing interface share a reference to the internal stream; and
the internal stream has a reference to the session object.

4. The method of claim 3, wherein the user-facing interface releases the reference to the internal stream after sending a final data byte.

5. The method of claim 1, wherein the session object implements an HTTP/2 state machine (i) that fetches and packages data bytes from the internal stream to generate encoded frames and (ii) that returns the encoded frames to the session object.

6. The method of claim 5, wherein the HTTP/2 state machine registers the internal stream as a data source.

7. The method of claim 1 further comprising:
determining that the user-facing interface has sent a final data byte to the internal stream; and
returning the internal stream to an internal stream pool of the session object.

8. The method of claim 1 further comprising:
receiving a notification from the internal stream that the user-facing interface has been destroyed; and
terminating the new incoming web-based protocol stream.

9. The method of claim 1 further comprising:
receiving a notification from the internal stream that the user-facing interface has been destroyed; and
autocompleting the internal stream.

10. The method of claim 1, wherein the internal stream is a first internal stream associated with a web-based protocol connection, and the user-facing interface is a first user-facing interface, the method further comprising:
generating a second internal stream for a second new web-based protocol stream associated with the web-based protocol connection;
transferring a set of data associated with the second new web-based protocol stream to a buffer of the second internal stream, wherein a second user-facing interface of the web server reads data from the buffer; and
in response to a first data byte sent by the second user-facing interface, initiating an active write loop for the second new web-based protocol stream.

11. The method of claim 10, wherein:
the user-facing interface is one of a plurality of user-facing interfaces; and
each stream is associated with a respective user-facing interface in the plurality of user-facing interfaces.

12. The method of claim 1, wherein the session is a first session associated with a first web-based protocol connection, wherein the web server comprises a plurality of sessions each associated with a different web-based protocol connection in a plurality of web-based protocol connections.

13. The method of claim 1, wherein the web-based protocol connection is an HTTP/2 connection.

14. A non-transitory machine readable medium storing a program for execution by a set of processing units, the program for facilitating a multi-stream protocol for a split web server comprising a reactor core and a proactor interface, the program comprising sets of instructions for:
at a session object of the web server:
generating an internal stream for a new incoming web-based protocol stream;
transferring a set of data associated with the new incoming web-based protocol stream to a buffer of the internal stream, wherein a user-facing interface of the web server reads data from the buffer; and
in response to a first data byte sent by the user-facing interface, initiating an active write loop for the new web-based protocol stream.

15. The non-transitory machine readable medium of claim 14, wherein:
the reactor core of the web server comprises the session object and the internal stream; and
the proactor interface comprises the user-facing interface.

16. The non-transitory machine readable medium of claim 15, wherein:
the session object and the user-facing interface share a reference to the internal stream; and
the internal stream has a reference to the session object.

17. The non-transitory machine readable medium of claim 16, wherein the user-facing interface releases the reference to the internal stream after sending a final data byte.

18. The non-transitory machine readable medium of claim 14, wherein the session object implements an HTTP/2 state machine (i) that fetches and packages data bytes from the internal stream to generate encoded frames and (ii) that returns the encoded frames to the session object.

19. The non-transitory machine readable medium of claim 18, wherein the HTTP/2 state machine registers the internal stream as a data source.

20. The non-transitory machine readable medium of claim 14, the program further comprising sets of instructions for:
determining that the user-facing interface has sent a final data byte to the internal stream; and
returning the internal stream to an internal stream pool of the session object.
